(19) United States
(12) Patent Application Publication
(10) Pub. No.: US 2015/0017995 A1
(43) Pub. Date: Jan. 15, 2015

(54) UPDATING OF COVERAGE AREA REPRESENTATIONS FOR A HIERARCHY OF COVERAGE AREAS

(71) Applicant: Nokia Corporation, Espoo (FI)

(72) Inventors: Lauri Aarne Johannes Wirola, Tampere (FI); Tommi Antero Laine, Tampere (FI); Jari Syrhärinne, Tampere (FI)

(21) Appl. No.: 14/383,556

(22) PCT Filed: Mar. 15, 2012
(86) PCT No.: PCT/IB2012/051235

§ 371 Date: Sep. 6, 2014

(51) Int. Cl. H04W 16/24; H04W 4/02

(52) U.S. Cl. CPC H04W 16/24; H04W 4/02
USPC 455/446

(57) ABSTRACT

It is inter alia disclosed to update or to trigger updating of a second-layer coverage area representation of a second-layer coverage area at least in dependence on a decision whether a first-layer coverage area representation of a first-layer coverage area has changed to an extent that exceeds a pre-defined or determined extent or not. The first-layer coverage area and the second-layer coverage area are part of a hierarchy of coverage areas of a communication system. The second-layer coverage area at least comprises the first-layer coverage area.

### FIELD

Embodiments of this invention relate to the field of updating coverage area representations to be provided to and used by terminals for positioning purposes, and in particular relates to updating of coverage area representations for a hierarchy of coverage areas.

### BACKGROUND

As an alternative or add-on to satellite-based positioning systems, positioning systems in which a present position of a terminal is estimated based on an identification of coverage areas that can currently be detected by the terminal have gained recent interest. For instance, a terminal may identify all coverage areas it is currently able to detect, which are provided by Coverage-Providing Entities (CPEs) (such as for instance base stations of a cellular Communication System (CS), or Wireless Local Area Network (WLAN) Access Points (APs) as an example of CPEs of a non-cellular CS), and consult a local or remote database (a so-called radiomap database) that provides Coverage Area Representations (CARs, e.g. models for the coverage areas) for the identified coverage areas.

In a simple case, such a CAR may at least comprise the position of the CPE (e.g. a WLAN access point) that provides the coverage area detected by the terminal. In more elaborate cases, a CAR may for instance describe the position, dimensions and orientation of an elliptical model of the coverage area provided by the CPE (e.g. a base station of a cellular mobile communication system).

For instance, given that (only) the positions of the CPEs of the detected coverage areas are known at the terminal, and distances from the terminal to the heard CPEs can be estimated, the terminal's position can be estimated through triangulation. The distance between a terminal and the heard CPEs can for instance be estimated based on the path loss using a channel model (i.e. how much the signal attenuates between the terminal and the CPE) or based on timing (or round-trip timing) measurements (i.e. information expressing how long signals propagate between terminal and CPE).

Alternatively, if more elaborate CARs are available, a terminal may pick the CARs for the detected coverage areas and find the intersection of these CARS. The terminal can then be assigned a position that is, for instance, the center-of-mass of the intersection area. Similarly, an error estimate for the position estimate can be given, for example, based on the size of the intersection.

The CARS can for instance be generated based on a plurality of detections performed by collector terminals that are able to determine their current position (e.g. by means of satellite-based positioning) and to identify the coverage areas that they can currently detect. The collector terminals then assemble and provide this information (in the form of a so-called fingerprint) in a crowd-sourcing approach to a server or cloud that selectively analyzes the fingerprints received with respect to each coverage area. For instance, from all fingerprints received, the server may extract all positions at which terminals were able to detect a specific coverage area. A representation of the boundary and/or shape of this plurality of positions, e.g. an ellipse fitted to this boundary and/or the mean value plus covariance of the samples, then already can serve as a CAR for this specific coverage area. Similarly, respective CARs for further coverage areas can be extracted.

### SUMMARY OF SOME EMBODIMENTS OF THE INVENTION

Due to the random nature of the crowd-sourcing approach for obtaining fingerprints, it may not always be possible to gather enough information to compute respective CARs for all coverage areas of a communication system. In order to nevertheless be able to provide a position estimate in cases where one or more respective CARs of coverage areas detected by a terminal are not available, it is advantageous to exploit the fact that communication systems often exhibit an hierarchically layered structure of coverage areas and to model not only the lower-layer coverage areas of the communication system, which may for instance be provided by respective CPEs, but also to model higher-layer coverage areas of the communication system that are respectively composed of one or more lower-layer coverage areas of the communication system. As a non-limiting example, in a cellular communication system according to the Global System for Mobile Communications (GSM), a lower-layer coverage area is a cell and identified by a Cell Identifier (CID), a next higher-layer coverage area is a location area and identified by a Location Area Code (LAC), a next higher-layer coverage area is represented by the area identified by a Mobile Network Code (MNC), and a next higher-layer coverage area is represented by the area identified by a Mobile Country Code (MCC). Therein, a location area comprises one or more cells, the area identified by the MNC comprises one or more location areas and the area identified by the MCC comprises one or more areas identified by respective MNCs. Thus, if a CAR for a specific cell (identified by the CID) is not available, but if a CAR for this cell is required for positioning, it is still possible to fall back on the CAR of the location area (identified by the LAC) that comprises the cell (if this CAR is available). The positioning accuracy may then be worse as compared to the case where a CAR for the desired cell would be available (since the location area is larger than the cell), but at least some positioning estimate can be given. For instance, when positioning is used to provide a reference position for an Assisted-GNSS (Global Navigation Satellite System)-based technique, an accuracy of 50 km may still deliver adequate results. Thus even though a CAR for a lower-layer coverage area (e.g. a cell) might be unknown in a positioning database, it is very probable that samples have been received for a higher-layer coverage area (e.g. a location area), because there are a plurality of lower-layer coverage areas under it, so that a CAR is known for it in the database.

Now, when a collector terminal provides a fingerprint to the server that updates (or “learns”) the CARs, the same fingerprint can be used to update the CARs of both the lower-layer and higher-layer coverage areas easily. For instance, when the server receives a fingerprint with a position for a GSM cell that is identified by the following Distinguished Name (DN) chain: MCC-MNC-LAC-CID=1-1-1-1, the server can of course update the CAR of the cell MCC-MNC-LAC-CID=1-1-1-1, but also the CAR of the location area MCC-MNC-LAC=1-1-1, the CAR of the area identified by the MNC MCC-MNC=1-1 and the CAR of the area identified by the MCC MCC=1.

However, the problem exists that under each location area (identified by the LAC) there may be up to 65536 cells (identified by CIDs). Therefore, there is potentially a huge number of fingerprints available for updating a CAR of location area, which leads to the performance problems. As an example, if the system received ten fingerprints for each cell every day, then each location area would receive 10*65536 fingerprints each day. Moreover, anyhow the majority of the samples received for a given location area would be redundant, since they are likely to lie within the already existing CAR for the location area and thus would not change the shape of the CAR.

The problem obviously gets even worse for CARs of even higher-layer coverage areas: under each MNC, there can be 2³² cells. Therefore, given that each cell receives just one fingerprint per day, then each MNC would get, in theory, 2³²≈4.3·10⁹ samples per day.

It is thus, inter alia, an object of the invention to enable an efficient and low-complexity updating of CARs of higher-layer coverage areas of a hierarchy of coverage areas of a communication system.

An example embodiment of the invention is a method performed by an apparatus (or by a system), the method comprising updating or triggering updating of a second-layer CAR of a second-layer coverage area at least in dependence on a decision whether a first-layer CAR of a first-layer coverage area has changed to an extent that exceeds a pre-defined or determined extent or not, wherein the first-layer coverage area and the second-layer coverage area are part of a hierarchy of coverage areas of a communication system, and wherein the second-layer coverage area at least comprises the first-layer coverage area.

A further example embodiment of the invention is an apparatus (or a system) that is configured to perform or comprises respective means for performing at least the respective operations or method steps of the above-described method. The means of this apparatus (or system) can be implemented in hardware and/or software. They may comprise for instance a processor for executing program code for realizing the required functions, a memory storing the program code, or both. Alternatively, they could comprise for instance a circuitry that is designed to realize the required functions, for instance implemented in a chipset or a chip, like an integrated circuit. Further alternatively, the means could be functional modules of a computer program code.

A further example embodiment of the invention is an apparatus (or a system) that comprises at least one processor and at least one memory including computer program code, the at least one memory and the computer program code configured to, with the at least one processor, cause the apparatus (or the system) at least to perform the operations of the above-described method. The computer program code included in the memory may for instance at least partially represent software and/or firmware for the processor. Non-limiting examples of the memory are a RAM or ROM that is accessible by the processor.

Non-limiting examples of the apparatus are a server or a portable electronic device, e.g. a positioning device or a mobile phone. The apparatus may for instance comprise at least one of a user interface, an antenna and communication network interface. Non-limiting examples of a system are a plurality of interconnected computers or processors for providing services, for instance in the form of a “cloud”.

A further example embodiment of the invention is a computer program according to the invention that comprises respective program code for performing at least the operations of the above-described method when the computer program is executed on a processor. The computer program may for instance be stored on a computer-readable storage medium, which may for instance be a tangible storage medium. The computer program may for instance be distributable over a network, e.g. the Internet. The computer program may for instance be a so-called “App”.

According to these example embodiments, for instance, a second-layer (e.g. higher-layer) CAR for a second-layer coverage area is only updated (e.g. learned and/or adapted to changes) or its updating is only triggered if it has been decided that a substantial change of a first-layer (e.g. lower-layer) CAR for a first-layer coverage area has occurred. In this way, position information (e.g. fingerprints) may for instance cause updating of the first-layer CAR, but may not necessarily cause also updating of the second-layer CAR. This vastly reduces the frequency of update operations on the second-layer CAR, which is particularly advantageous if the second-layer coverage area comprises a large number of first-layer coverage areas.

Other features of the invention will be apparent from and elucidated with reference to the detailed description presented hereinafter in conjunction with the accompanying drawings. It is to be understood, however, that the drawings are designed solely for purposes of illustration and not as a definition of the limits of the invention, for which reference should be made to the appended claims. It should further be understood that the drawings are not drawn to scale and that they are merely intended to conceptually illustrate the structures and procedures described therein. In particular, presence of features in the drawings should not be considered to render these features mandatory for the invention.

### BRIEF DESCRIPTION OF THE FIGURES

In the figures show:

FIGS. 1a to 1b: schematic illustrations of operation modes of a system to which example embodiments of the invention pertain;

FIG. 2: an example of a coverage area hierarchy in a GSM/EDGE communication system;

FIG. 3: a flowchart of an example embodiment of a method according to the invention;

FIG. 4: a flowchart of an example embodiment of a method according to the invention,

FIG. 5: a flowchart of an example embodiment of a method according to the invention,

FIGS. 6a to 6b: schematic illustrations of coverage area representations of a hierarchy of coverage areas updated according to example embodiments of the invention;

FIG. 7: a schematic block diagram of an example embodiment of an apparatus according to the invention; and

FIG. 8: a schematic illustration of an example embodiment of a tangible storage medium according to the invention.

### DETAILED DESCRIPTION OF EMBODIMENTS OF THE INVENTION

Modern global cellular and non-cellular positioning technologies are based on assembling large global databases containing information on the location-dependent receivability of signals of cellular communication systems (e.g. Global System for Mobile Communication (GSM), Wideband Code Division Multiple Access (WCDMA), Time Division Synchronous Code Division Multiple Access (TD-SCDMA), Long-Term Evolution (LTE), LTE Advanced (LTE-A), Code Division Multiple Access (CDMA) etc.) and non-cellular communication systems (e.g. a Wireless Local Area Network (WLAN), a Bluetooth (BT) system, a Bluetooth Low Energy (BTLE) system, a Zigbee system, a Worldwide Interoperability for Microwave Access (WiMAX) system, a Radio-Frequency IDentification (RFID) system, a broadcasting system such as for instance Digital Video Broadcasting (DVB), a Digital Audio Broadcasting (DAB) system or a Frequency-Modulated (FM)/Amplitude-Modulated (AM) radio system, a Near Field Communication (NFC) system, etc.). This data inter alia originates from users of these positioning technologies.

The data from the users is typically in the form of so-called “fingerprints”, which contain a Global Navigation Satellite System (GNSS)-based location estimate and measurements taken from the cellular and/or non-cellular radio interfaces. These measurements may contain one or more of the following:
global and/or local identifiers (IDs) of the cellular network cells observed and, possibly, signal strength and/or path-loss estimates,
timing measurements (Timing Advance or Round-Trip Time),
Basic Service Set Identifiers (BSSIDs) (e.g. Medium Access Control (MAC) addresses) of the WLAN access points observed and, possibly, Service Set Identifiers (SSIDs),
signal strengths (e.g. received signal strength index, physical Rx level in dBm ref 1 mW, etc.).

This data gets uploaded to a server or cloud, where algorithms are run to generate CARs of coverage areas for positioning purposes. In the end, the CARS are transferred back to user terminals for use in position determination.

Therein, a coverage area may for instance be understood as an area in which one or more Coverage-Providing Entities (CPEs) provide coverage (e.g. radio coverage). Non-limiting examples of CPEs are CPEs of wire-bound or wireless communication systems. For instance, a CPE may be a base station of a cellular radio communication system, such as for instance a second generation (2G), third generation (3G) or fourth generation (4G) communication system, examples of which are given above, or an access point or beacon of a non-cellular radio communication system, with according examples also given above.

Terminals located within a coverage area are for instance enabled to at least receive and decode an identifier from at least one of the one or more CPEs and/or to communicate in a communication system of which the one or more CPEs are a part of. A coverage area in case of radio coverage generally depends on a plurality of parameters of both the CPE (inter alia antenna beamwidth and positioning, transmission power) and the propagation environment (inter alia path-loss and shadowing caused by obstructing elements).

A CAR is associated with a coverage area. A CAR of a coverage area may for instance be or at least be desired to be representative of a coverage area. However, at least temporary deviations may occur between the CAR and the actual coverage area, for instance in case of changes or movement of the coverage area.

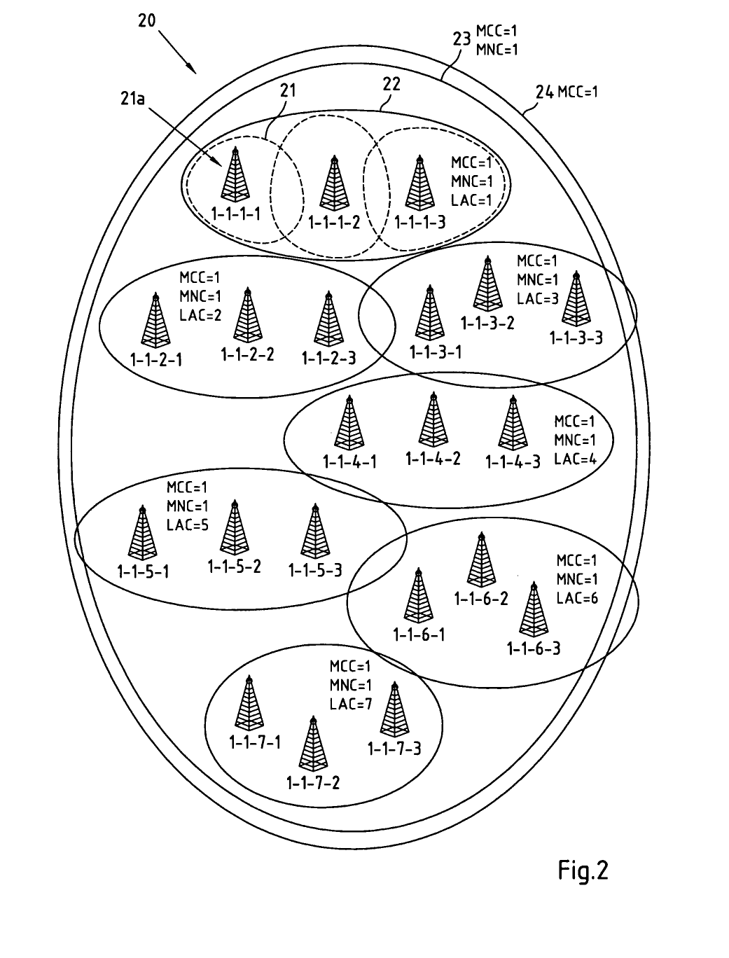

A CAR may for instance be a model for a coverage area (or may be a position of a CPE, or may be a radio propagation model, etc.). This model may for instance be a model representing hard boundaries of a coverage area, or a model that represents a coverage area in a statistical sense, for instance by means of a probability (density) function. An example of such a statistical representation of a coverage model is a multi-normal distribution. A CAR may relate to a coverage area provided by a single CPE, but may equally well relate to coverage areas of multiple CPEs. A CAR may for instance relate to a coverage area of a Radio Network Controller (RNC) or of a coverage area specified by a Location Area Code (LAC), or even to a coverage area of an operator or country, as will be described below with reference to FIG. 2.

A CAR may only be a coarse model of a coverage area, e.g. an elliptical or polygonal model. The CAR may equally well be constituted by a set of one or more grids (selectively) taken from a grid of regions. Then a granularity of the CAR may be defined by the granularity of the grid of regions.

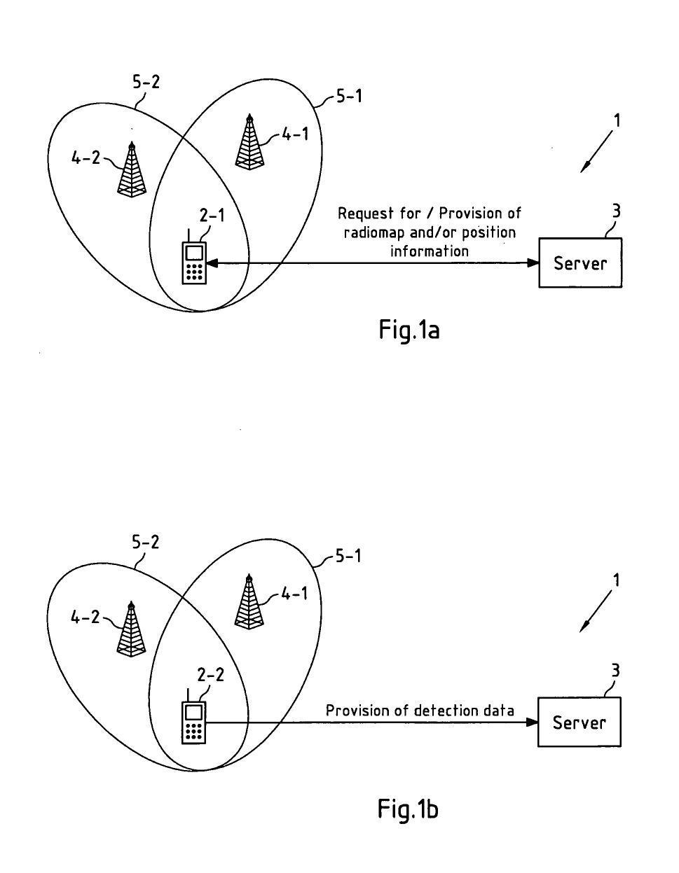

FIGS. 1a and 1b schematically illustrate different operation modes of a system 1 to which embodiments of the invention pertain. FIG. 1a relates to a consumer mode of system 1, and FIG. 1b relates to a collector mode thereof.

System 1 comprises a terminal 2-1 (see FIG. 1a) or 2-2 (see FIG. 1b) and a server 3, which may equally well be representative of a cloud-based service. Server 3 comprises or has access (for instance via a network, which is not shown in FIGS. 1a and 1b) to a radiomap database. In the radiomap database, information on a plurality of (CARs) is stored. For instance, information on respective CARs of coverage areas 5-1 and 5-2 respectively provided by coverage providing entities (CPEs) 4-1 and 4-2 are stored in the radiomap database. For instance, the plurality of CARs and identifiers related to the coverage areas associated with the CARs (and/or their CPEs) may be stored in the radiomap database. A CAR of a coverage area is desired to be representative of the coverage area, but at least temporary deviations may occur between the CAR and the coverage area. Furthermore, a CAR may only be a coarse model of the coverage area, for instance a grid-based model, an elliptical model, or a polygon.

In FIG. 1a (consumer mode), the position of consumer terminal 2-1 may for instance have to be determined at least partially based on CAR information stored in the radiomap database. For instance, terminal 2-1 may determine its position in a terminal-based manner based at least on radiomap information requested from and provided by server 3. For instance, terminal 2-1 locally stores at least a partial copy of the radiomap database such that the terminal 2-1 can determine its (current) position locally at least partially based on the local copy of the radiomap database and on an identification of the respective coverage areas 5-1 and 5-2 of CPEs 4-1 and 4-2 which terminal 2-1 (currently) is able to detect.

Therein, a coverage area may for instance be detected by a terminal if the terminal is able to receive one or more signals (e.g. a broadcast channel), which are sent by the CPE providing the coverage area, with a pre-defined minimum quality (for instance defined in terms of a signal-to-noise ratio or a signal-to-noise and interference ratio), and/or may be able to at least partially receive and correctly decode one or more signals sent by the CPE providing the coverage area (e.g. a broadcast channel), and/or may be able to receive and correctly decode an identifier of the CPE that provides the coverage area (for instance a MAC address or another identifier). Receiving signals or information from the CPE (and thus detecting a coverage area provided by the CPE) may for instance require that the terminal is technically capable to receive such signals or information. Thus a terminal may have to support the transmission technology (e.g. the communication standard) used by the CPE. Receiving signals or information from the CPE (and thus detecting a coverage area provided by the CPE) may also require that the terminal is entitled to communicate with or at least receive signals or information from the CPE.

Alternatively or additionally to determining a position estimate based on a local copy of the radiomap database at terminal 2-1, terminal 2-1 may request position information from server 3. For instance, terminal 2-1 may provide a so-called fingerprint for instance comprising identifiers of the coverage areas 5-1 and 5-2 provided by CPEs 4-1 and 4-2 which terminal 2-1 (currently) detects to server 3. At least partially based on the radiomap database and the fingerprint, server 3 may then determine the (current) position of terminal 2-1 and provide corresponding position information to terminal 2-1. This allows reducing the complexity and power consumption of consumer terminal 2-1.

Note that even in case the end user terminal 2-1 has GNSS-capability itself, the end user can still benefit from (additionally) using cellular/non-cellular positioning technologies, for instance in terms of time-to-first-fix (a measure of the time required for a GNSS receiver to acquire satellite signals and navigation data and calculate a position solution, called a fix) and power consumption. Also, not all applications require a GNSS-based position. Furthermore, cellular/non-cellular positioning technologies also work indoors, which is generally a challenging environment for GNSS-based positioning technologies.

In FIG. 1b (collector mode), collector terminal 2-2 collects information based on which the CARs stored in the radiomap database are maintained and updated. Terminal 2-2 may be capable of determining its (current) position, for instance based on an (Assisted) Global Navigation Satellite System (A)GNSS receiver attached to or integrated in terminal 2-2. For instance, terminal 2-2 may alternatively/additionally be capable of determining its (current) position in a terminal based manner, for instance at least partially based on a local copy of a radiomap database and on coverage areas provided by CPEs different from CPEs 4-1 and 4-2 (e.g. CPEs operated according to a different communication system) which terminal 2-2 (currently) detects. For instance, collector terminal 2-2 may determine its position based on WLAN CPEs/coverage areas, and may report this determined position with a list of currently detected coverage areas of another (e.g. cellular) communication system. For instance, collector terminal 2-2 may provide detection data comprising the current position of terminal 2-2 and the identifiers of coverage areas 5-1 and 5-2 (or of the respective CPEs 4-1 and 4-2) currently detected at that position to server 3. Based on this detection data, server 3 may maintain/update the radiomap database.

Example embodiments of the invention are directed to efficiently updating CARs, in particular CARs of higher-layer coverage areas that form part of a hierarchy of coverage areas of a communication system. For instance, consider a case where a terminal to be positioned (like terminal 2-1 of FIG. 1a) has detected a lower-layer coverage area, but no CAR is (yet) available for this lower-layer coverage area in the radiomap database, for instance because this coverage area has been newly deployed. As a valuable fall-back solution, still a CAR of the next higher-layer coverage area from the hierarchy of coverage areas can then be used, which generally has a wider extension (thus leading to a somewhat less accurate position estimate as compared to the lower-layer CAR), but has a higher probability of being available in the radiomap database.

Before describing the updating process for such higher-layer CARs in more detail, an illustrative example of a hierarchy of coverage areas in a communication system will be given with respect to FIG. 2.

FIG. 2 illustrates an example of a coverage area hierarchy 20 in a GSM/EDGE communication system. The hierarchy 20 is based on cell coverage areas 21, which are respectively provided by CPEs 21a and form the lowest layer (Layer-1) of the hierarchy 20. Each cell coverage area can be identified by the GERAN DN, which is given as a tuple of four identifiers MCC-MNC-LAC-CID (e.g. “1-1-1-1”). Respective cell coverage areas 21 of multiple cells form a coverage area 22 of a location area (Layer-2). For instance, the cell coverage areas 21 identified by the Distinguished Name (DN) chains 1-1-1-1, 1-1-1-2 and 1-1-1-3 are comprised in the coverage area 22 of the location area identified by MCC=1, MNC=1 and LAC=1 (wherein it is understood that the number of 3 cell coverage areas 21 forming a coverage area 22 of a location area is exemplary only (it may be any number in the range from 1 to 65535) and can also be different for different location areas). In turn, respective cell coverage areas 22 of multiple location areas form a coverage area 23 of a network (Layer-3). In the example of FIG. 2, exemplarily only a coverage area 23 of one network is shown, which comprises the coverage areas 22 of all location areas and is identified by MCC=1 and MNC=1. Furthermore, the coverage area 23 of the network is comprised in the coverage area 24 of a country (Layer-4), which is identified by MCC=1.

Therein, it is understood that the coverage area 24 could equally well comprise respective coverage areas 23 of more than one network, and that these coverage areas 23 could also overlap each other.

Furthermore, with reference to the table below, some examples of hierarchies of coverage areas in various communication systems will be given, in particular for a GSM (with a GSM Enhanced Data Rates for GSM (EDGE) Radio Access Network (GERAN)), for a Universal Mobile Telecommunication System (UMTS) (with a UMTS Radio Access (UTRA) Frequency Division Duplex (FDD)/Time Division Duplex (TDD) network), for an Evolved UMTS (with an Evolved UTRA (E-UTRA)) and for a CDMA system.

| Radio Access | | | Part |
|---|---|---|---|
| Network | Cell DN | Fallback options | of DN |
| GERAN | MCC-MNC-LAC-CID | MCC (Layer-4) | Yes |
| | | MNC (Layer-3) | |
| | | LAC (Layer-2) | |
| UTRA-FDD/TDD | MCC-MNC-UCID | MCC (Layer-4) | Yes |
| | | MNC (Layer-3) | |
| | | RNC (Layer-2) | |
| | | LAC (Layer-2) | No |
| E-UTRA | MCC-MNC-CID | MCC (Layer-4) | Yes |
| | | MNC (Layer-3) | |
| | | eNodeB (Layer-2) | |
| | | TAC (Layer-2) | No |
| CDMA | SID-NID-BSID | SID (Layer-3) | Yes |
| | | NID (Layer-2) | |
| | | RZ (Layer-2) | No |

Therein, the first column identifies the respective communication system/radio access network, the second column contains a respective DN chain of identifiers of the coverage areas of the hierarchy of coverage areas of the communication system/radio access network, the third column lists the respective higher-layer coverage areas as possible fall-back options in case that a CAR for the lowest-layer coverage area is not available, and the fourth column respectively describes which of the higher-layer coverage areas of the third column are part of the DN and which are not, as will be further explained below.

Therein, it is assumed that the lowest layer (Layer-1) is the layer of the cell coverage area (identified by the CID, UCID or BSID), and the higher-layers above are assigned increasing numbers (Layer-2, Layer-3, Layer-4). This refers to the natural hierarchy in cellular network naming. Therein, the cells (Layer-1) are directly associated with Layer-2 coverage areas (like LAC, eNodeB, TAC, NID, RZ). Layer-2 coverage areas are in turn associated with Layer-3 coverage areas, which are in turn associated with Layer-4 coverage areas. Therein, in case of GERAN, UTRA-FDD/TDD and E-UTRAN, the Layer-3 coverage areas pertain to networks, and Layer-4 coverage areas pertain to countries.

In addition to the abbreviations MCC, MNC, LAC and CID already introduced before, the above table refers to the following abbreviations:

### UCID—UTRA Cell ID

### RNC—Radio Network Controller

eNodeB—Base station in E-UTRA networks

### TAC—Tracking Area Code

### SID—System ID

### NID—Network ID

### BSID—Base Station IDentity

### RZ—Registration Zone.

Potential higher-layer fall-back coverage areas can for instance be directly derived from the DN chain identifying the lowest-layer coverage area (for instance, if a coverage area of a cell of a GERAN network is identified by the DN MCC-MNC-LAC-CID=1-1-7-3, a first choice of a fall-back coverage area may be the coverage area of the location area defined by the DN MCC-MNC-LAC=1-1-7).

There are a few items here that require explanation:
In case of UTRA, the UCID (28 bits) consists of two parts: the upper 12 bits denote the RNC-ID, and the lower 16 bits denote the Cell ID under the RNC. The RNC-ID can be used as the fall-back.
In case of UTRA, there is a LAC similar as in GERAN networks. However, the LAC is not part of the cell Distinguished Name, but is a separate identity. Nevertheless, a terminal is aware of its LAC in UTRA networks, and thus it can be used as fall-back method in positioning.
In case of E-UTRA, the CID (28 bits) consists of two parts: the upper 20 bits denote the eNodeB-ID, and the lower 8 bits denote the Cell ID under the eNodeB. The eNodeB-ID can be used as the fall-back.
In case of E-UTRA, there is a TAC (Tracking Area Code), which is similar to UTRA LAC (not part of DN, but the terminal always knows its TAC). The same applies to CDMA RZ.

From the positioning perspective, the fall-back methods follow the layering. So in case that a CAR for a cell (Layer-1) is unknown to the radiomap database, the CAR of the coverage area with the associated Layer-2 ID is used for fall-back purposes. In case of GERAN, this is obviously the CAR for the location area (Layer-2, LAC), but in case of UTRA, the choice needs to be made between the CAR of the coverage areas identified by the LAC or by the RNC. It's a matter of taste which one to utilize. However, in case CARs for the coverage areas identified by both the LAC and the RNC are unknown to the database, the next fall-back is the CAR of the coverage area identified by the MNC, and the last one is the CAR of the coverage area identified by the MCC.

As detailed in the introduction, the amount of samples (fingerprints or information derived therefrom) received for cells under a given LAC may be so high that it is not feasible to use all of the samples to update the CAR for the coverage area identified by the LAC. Therefore, the number of samples provided for updating the CAR for the coverage area identified by the LAC needs to be reduced. Further, as described, the number of samples received for a given MNC or MCC is even greater meaning that not all the samples can be processed—and they shouldn't be because most of the samples are redundant.

A solution proposed by example embodiments of the invention is to look for changes in the lower-layer CARs: A CAR for a cell is only used to update a CAR for a LAC in case the CAR for the cell changes. The CAR for the LAC is only used to update the CAR for the MNC in case the CAR for the LAC changes. And the CAR for the MNC is only used to update the CAR for the MCC in case the CAR for the MNC changes. Thus an idea of example embodiments of the invention is not to use cell samples to update all the (lower-layer and higher-layer) CARs, but to utilize the hierarchy so that in principle a Layer-N CAR (N={1,2,3}) only updates a Layer-(N+1) CAR, in case the Layer-N CAR changes.

A first example embodiment of the invention pertains to a method that comprises updating or triggering updating of a second-layer CAR of a second-layer coverage area at least in dependence on a decision whether a first-layer CAR of a first-layer coverage area has changed to an extent that exceeds a pre-defined or determined extent or not, wherein the first-layer coverage area and the second-layer coverage area are part of a hierarchy of coverage areas of a communication system, and wherein the second-layer coverage area at least comprises the first-layer coverage area.

Therein, the communication system may for instance be a cellular communication system, such as for instance a cellular mobile radio communication system. Non-limiting examples of such a cellular mobile radio communication system are a GSM system, a UMTS system, an E-UMTS or Long-Term Evolution (LTE) system or a CDMA system, as exemplarily discussed with reference to the table above.

Equally well, the communication system may for instance be a non-cellular communication system, as long as it exhibits a hierarchy of coverage areas.

The first-layer coverage area and the second-layer coverage area are part of a hierarchy of coverage areas (as for instance hierarchy 20 of FIG. 2), which may for instance have at least two different layers. The second-layer coverage area and the first-layer coverage area are hierarchically associated with each other. For instance, one or more first-layer coverage areas may compose a second-layer coverage area. In particular, the second-layer coverage area comprises the first-layer coverage area (but may of course completely or at least partially comprise further coverage areas). The first-layer coverage area may for instance be the lowest-layer coverage area of the hierarchy (for instance cell coverage area 21 in FIG. 2), but may equally well be a higher-layer coverage area of the hierarchy. The second-layer coverage area may for instance be the coverage area of the next higher layer above the first-layer coverage area (e.g. the coverage area 22 of a location area in FIG. 2), but may equally well be a coverage area that is more than one layer above the first-layer coverage area (e.g. the coverage area 23 or 24 in FIG. 2).

The first-layer CAR is a CAR of the first-layer coverage area, and the second-layer CAR is a CAR of the second-layer coverage area.

In example embodiments that are based on the first embodiment of the invention, the respective CAR of different layers of the hierarchy of coverage areas of the communication system are provided in a database (e.g. a radiomap database) to allow or at least support positioning of a mobile terminal based on an identification of one or more coverage areas the mobile terminal is associated with (e.g. the one or more coverage areas the mobile terminal is able to detect), wherein an accuracy of the positioning of the mobile terminal is highest when based on CARs of the lowest-layer coverage areas (e.g. the first-layer coverage area) and decreases when based on CA Rs of higher-layer coverage areas (e.g. the second-layer coverage area), and wherein CARs of higher-layer coverage areas serves as a fall-back solution in cases where CARs for lower-layer coverage areas with which the mobile terminal is associated are not or only partially available. Some examples for positioning a mobile terminal have already been discussed with respect to FIG. 1a above.

In example embodiments of the invention, the method according to the first embodiment of the invention further comprises deciding whether the first-layer CAR has changed to an extent that exceeds the pre-defined or determined extent or not, or comprises obtaining this decision (for instance from another functional unit of the apparatus that performs the method according to the first embodiment of the invention, or from an apparatus (or device) that is different from the apparatus (or device) that performs the method according to the first embodiment of the invention).

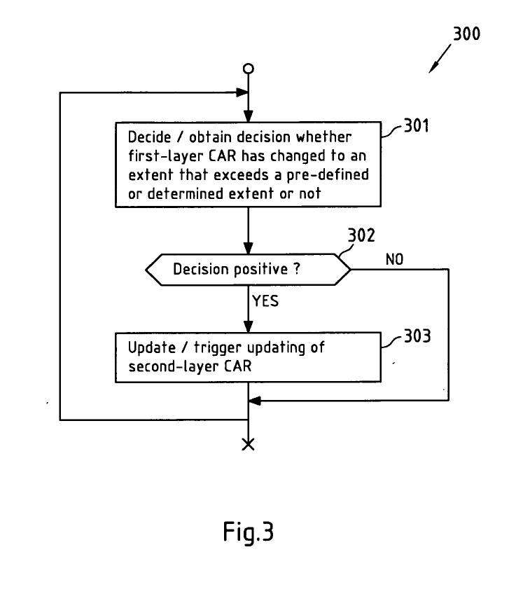

FIG. 3 shows a flowchart 300 of the method according to the first example embodiment of the invention. Therein, in a step 301, it is either decided whether the first-layer CAR has changed to an extent that exceeds a pre-defined or determined extent or not, or an according decision is obtained (for instance received from another unit or apparatus). In a step 302, it is then checked if this decision is positive. If this is the case, in a step 303, the second-layer CAR (which comprises the first-layer CAR) is updated, or updating of the second-layer CAR is triggered (e.g. by sending an according trigger event or trigger signal to an entity that is to perform the updating). Otherwise, the flowchart returns to step 301 (for the sake of simplicity of presentation, a termination condition for this endless-loop has been omitted, but may of course well be present).

It may thus for instance be imagined that the decision whether the first-layer CAR has changed to an extent that exceeds the pre-defined or determined extent or not is made by a first functional unit and provided to a second functional unit that obtains this decision in step 301 and then performs steps 302 and—conditioned on the result thereof—also step 303 by updating the second-layer CAR. Alternatively, it may for instance be imagined that a first functional unit performs steps 301 and 302, and in case of a positive decision, also step 303 by triggering a second functional unit to perform the updating of the second-layer CAR. In both scenarios, the first functional unit and the second functional unit may be part of or implemented by the same apparatus (e.g. a processor) or device, or may respectively be part of or implemented by different apparatuses (e.g. processors) or devices.

The updating of the second-layer CAR may comprise changing the second-layer CAR to reflect changes in the first-layer CAR that have been decided to exceed the pre-defined/determined extent. Such changes may for instance be considered as substantial changes, and may thus be considered to justify updating the second-layer CAR. The updating of the second-layer CAR may for instance comprise transforming the second-layer CAR into a changed second-layer CAR, which may for instance be a second-layer CAR representing a larger, smaller, differently shaped or moved coverage area, to name but a few examples. The changed second-layer CAR may for instance be stored in a database (e.g. the radiomap database, for instance the same database in which the unchanged second-layer CAR was stored, or another database).

The updating or the triggering of the updating of the second-layer CAR depends at least on the decision whether a first-layer CAR has changed to an extent that exceeds a pre-defined or determined extent or not, but may equally well depend on further information, such as for instance on one or more timestamps that are associated with the second-layer CAR or with part thereof, as will be discussed in further detail below.

According to the first embodiment of the invention, the decision whether the first-layer CAR has changed to an extent that exceeds the pre-defined or determined extent or not may be based on information pertaining to the first-layer CAR. Accordingly, the method according to the first embodiment of the invention may further comprise obtaining (e.g. receiving, for instance from a terminal) or generating such information.

For instance, such information may be indicative of a change of the first-layer CAR with respect to a previous version of the first-layer CAR. This information may for instance comprise one or more values indicative of the amount of change (for instance, if the first-layer CAR is described by geometrical model, such as for instance an elliptical model, the values may indicate relative and/or absolute changes of parameters (e.g. axis lengths, centre positions) of this geometrical model). Alternatively, this information may comprise one or more parameters that are representative of the first-layer CAR and of the previous version of the first-layer CAR.

Such information may for instance be obtained by a first functional unit that generates the decision from a second functional unit that generates such information. The second functional unit may for instance update the first-layer CAR (to transform the previous version of the first-layer CAR into the present version thereof), but equally well, also the updating of the first-layer CAR and the generation of the decision may be performed by the same functional unit.

The information pertaining to the first-layer CAR may for instance be position information provided by a terminal (e.g. collector terminal 2-2 of FIG. 1b) associated with the first-layer coverage area, e.g. a terminal that detects the first-layer coverage area when positioned at a position represented by the position information. This position information may for instance be part of a fingerprint, with a further part of the fingerprint identifying the first-layer coverage area and thus also the first-layer CAR. A fingerprint may of course comprise identifiers of more than one first-layer coverage area that is currently detected by the terminal. The position information (representing the position of the terminal) may then for instance be used to update the first-layer CAR of the first-layer coverage. For instance, if the position of the terminal is not yet covered by the previous version of the first-layer CAR, the first-layer CAR may be changed in the updating to cover the position of the terminal. If the position of the terminal is already covered by the previous version of the first-layer CAR, no updating/change of the first-layer CAR may take place. There may also be mechanisms in place to update the first-layer CAR in cases where the first-layer coverage area shrinks or moves, which mechanisms are however outside of the scope of this description. Nevertheless, all types of changes (e.g. growth, shrinking, movement, etc.) of the first-layer CAR may be considered in the decision whether the first-layer CAR has changed to an extent that exceeds the pre-defined or determined extent or not.

Therein, the pre-defined extent may for instance be a pre-defined (absolute or relative) value or measure. It may for instance be defined once (for instance during configuration of an apparatus or system that performs the updating of first-layer CARs), for instance depending on one or more parameters pertaining to the first-layer and/or second layer CARs (e.g. a grid element size of the first-layer and/or second-layer CAR), or may be determined at least before making the decision. The determined extent may for instance be adaptively determined, for instance depending on one or more parameters pertaining to the first-layer and/or second layer CARs (e.g. a grid element size of the first-layer and/or second-layer CAR). The pre-defined or (adaptively) determined extent may for instance be different for different types (e.g. coverage sizes and/or grid element sizes) of first-layer CARs.

In example embodiments of the invention, the method according to the first embodiment of the invention has the further features that the first-layer CAR is composed of a set of one or more grid elements of a first-layer grid, and that the first-layer CAR is decided to have changed to an extent that exceeds a pre-defined or determined extent if one or more grid elements have to be added or removed from a previous first-layer CAR to obtain the first-layer CAR. The grid elements may for instance all have the same geometry, for instance a square, rectangular, hexagonal, circular or elliptical geometry. The grid may for instance be a grid of quadrants obtainable by dividing a longitude axis and a latitude axis of the Earth into a plurality of quadrants of size x times y degrees, wherein x and y are real numbers.

The first-layer CAR is then represented in a granular fashion, wherein the resolution of the first-layer CAR is determined by the size of the grid elements. This granular representation allows for a computationally cheap storage of the first-layer CAR, since for instance only identifiers of the grid elements (e.g. A1, A2, C2, C4 . . . ) that compose the first-layer CAR have to be stored. The pre-defined/determined extent may then for instance be considered to be represented by the granularity of the first-layer grid, with changes of the first-layer CAR with respect to the grid (addition/removal of grid elements composing the first-layer CAR) being considered as a changes to an extent exceeding the pre-defined/determined extent.

A second example embodiment of the invention adds, to the first embodiment of the invention, the feature that the second-layer CAR is composed of a set of one or more grid elements of a second-layer grid. The grid elements may for instance all have the same geometry, for instance a square, rectangular, hexagonal, circular or elliptical geometry. The grid may for instance be a grid of quadrants obtainable by dividing a longitude axis and a latitude axis of the Earth into a plurality of quadrants of size x times y degrees, wherein x and y are real numbers. The second-layer CAR is then represented in a granular fashion, wherein the resolution of the second-layer CAR is determined by the size of the grid elements. This granular representation allows for a computationally cheap storage of the second-layer CAR, since for instance only identifiers of the grid elements (e.g. A1, A2, C2, C4 . . . ) that compose the second-layer CAR have to be stored. If also the first-layer CAR is composed of a set of one or more grid elements of a first-layer grid, the second-layer grid may for instance be coarser than the first-layer grid to reflect the hierarchy of coverage areas. The first layer-grid and the second-layer grid may for instance be adapted to each other. For instance, a second-layer grid element may consist of an integer number of first-layer grid elements.

Association of a second-layer grid element to the second-layer CAR may for instance be indicated by adding an identifier (e.g. an index) of this grid element into a list of identifiers of all second-layer grid elements comprised in the second-layer CAR. Equally well, a grid element may be indicated to be part of the second-layer CAR if, for the grid element, information has been stored. Such information may for instance be an identifier of the first-layer CAR the (substantial) change of which caused the addition or refreshing of the grid element and/or a timestamp (for instance indicating a time when the grid element was added to the second-layer CAR or refreshed in the second-layer CAR).

The updating of the second-layer coverage area may for instance comprise adding and/or removing one or more grid elements of the second-layer grid to/from the second-layer CAR (for instance by adding/removing identifiers of the one or more grid elements to/from the list of identifiers of all second-layer grid elements comprised in the second-layer CAR), or by storing information for the one or more grid elements or deleting information stored for the one or more grid elements.

Each second-layer coverage area may for instance be associated with a respective second-layer grid. These second-layer grids may be portions of a larger grid (and may all have the same grid element size). Having respective second-layer grids for each second-layer coverage area may allow having small-size second-layer grids with small numbers of grid elements (compared to one grid for all second-layer coverage areas) and, consequently, also smaller numbers of indices required for indexing the respective grid elements. This saves storage space required for storing the grid element indices. The position of a second-layer grid in the large grid may then for instance be indicated by offset coordinates with respect to a reference point in the large grid.

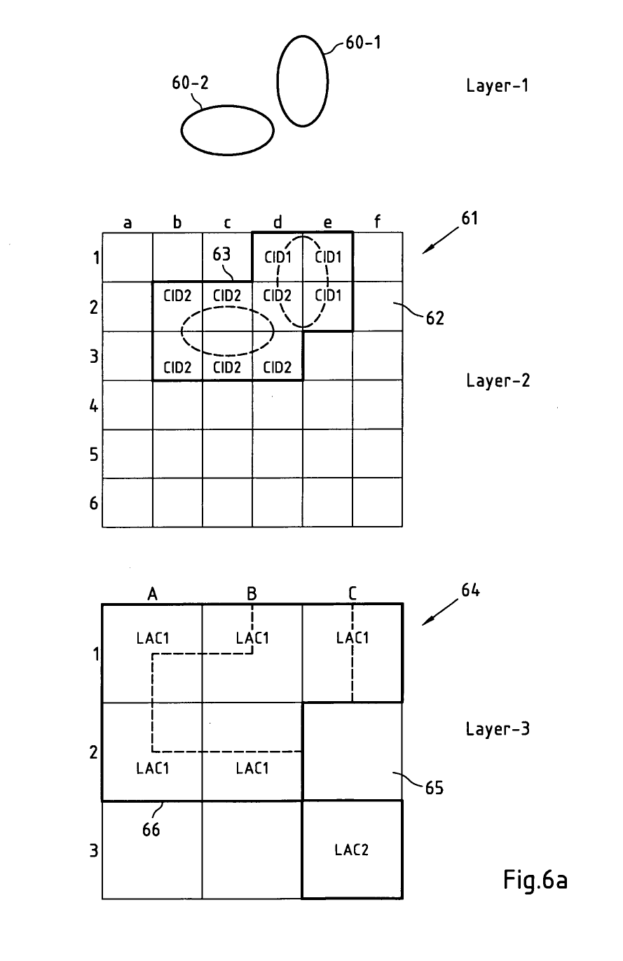

FIG. 6a, in the topmost two subfigures (referring to Layer-1 and Layer 2 of a hierarchy of coverage areas, respectively), exemplarily illustrates how a second-layer CAR 63 (having a bold frame) is composed of a plurality of second-layer grid elements 62 of a second-layer grid 61. The second-layer CAR 63 represents a second-layer coverage area (e.g. a location area), which comprises two first-layer coverage areas (e.g. cells). The two first-layer coverage areas are represented by respective first-layer CARs 60-1 and 60-2, which are exemplarily chosen as elliptical coverage models. Second-layer CAR 63 may for instance have been generated in a learning process, wherein (for instance the appearance or change of) the first-layer CAR 60-2 caused addition of second-layer grid elements b2, c2, d2, b3, c3 and d3 to the second-layer CAR 63, and wherein (for instance the appearance or change of) the first-layer CAR 60-1 caused addition of second-layer grid elements d1, e1 and e2 to the second-layer CAR 63. It can be readily seen from the topmost two subfigures of FIG. 6a that, due to the granularity of the second-layer grid 62, the second-layer CAR 63 is a much coarser CAR model as compared to the sum of the two first-layer CAR models 60-1 and 60-2.

In example embodiments of the invention, the second embodiment of the invention has the further feature that the first-layer CAR is decided to have changed to an extent that exceeds a pre-defined or determined extent if one or more grid elements have to be added or removed from the second-layer CAR to reflect the changes in the first-layer CAR. Updating of the second-layer CAR may then only be performed or triggered if it is decided that a change in the first-layer CAR causes addition or removal of one or more second-layer grid elements from the second-layer CAR, which may be considered a necessary update of the second-layer CAR. The pre-defined/determined extent may then for instance be considered to be represented by the granularity of the second-layer grid, with changes of the second-layer CAR with respect to this grid (addition/removal of grid elements composing the second-layer CAR) being considered as a changes to an extent exceeding the pre-defined/determined extent.

In example embodiments of the invention, the second embodiment of the invention has the further feature that the first-layer CAR is decided to have changed to an extent that exceeds a pre-defined or determined extent if an amount of change of at least one parameter of the first-layer CAR exceeds a pre-defined or determined threshold. Said threshold may for instance equal a dimension of a second-layer grid element of the second-layer grid multiplied by a factor that is larger than 0 and smaller than or equal to 1. Said factor may for instance be 0.5. For instance, in case of the second-layer grid being a grid of square grid elements (a checkerboard grid), the threshold may for instance be chosen as half a grid element size. If the first-layer CAR is an elliptical model (e.g. with the following parameters: centre position as longitude and latitude (e.g. in World Geodetic System WGS-84), lengths of the semi-major and semi-minor axes (e.g. in meters, referring to WGS-84 coordinates), and orientation of the semi-major axis (e.g. in degrees, e.g. clock-wise from North), the first-layer CAR may for instance be considered to have changed to an extent that exceeds the pre-defined/determined extent if at least one of the semi-major/semi-minor axes changes by an amount that exceeds half the second-layer grid element size, or if the centre position moves a distance that is larger than half the second-layer grid element size. It may be advantageous to couple the extent of change of the first-layer CAR that causes an updating of the second-layer CAR to a dimension of the second-layer grid elements, so that there is a high probability that a change of the first-layer CAR that exceeds such an extent also impacts the second-layer CAR.

A third example embodiment of the invention adds, to the second embodiment of the invention, the feature that for each second-layer grid element that has been (newly) added to or refreshed in the second-layer CAR in a previous updating of the second-layer CAR based on a decision that a first-layer CAR of a first-layer coverage area has changed to an extent exceeding a pre-defined or determined extent, an identifier of this first-layer CAR (which for instance also identifies the coverage area represented by the CAR) is stored. A second-layer grid element may for instance be considered to be refreshed if it is already present in the second-layer CAR and only new information (such as for instance a timestamp) is associated with it. Storing a first-layer CAR identifier for an added/refreshed second-layer grid element may serve as an indication that this grid element belongs to the second-layer CAR (for instance, only grid elements of the second-layer grid that have identifiers stored for them may be considered to compose the second-layer CAR) and/or may be useful for allowing quick removal of second-layer grid elements in case the first-layer coverage area of the identified first-layer CAR disappears or substantially moves, as will be further discussed below.

Therein, for a second-layer grid element of a second-layer CAR, only an identifier of one first-layer CAR may be stored, although the second-layer grid element may be affected by changes of more than one first-layer CAR (e.g. in case of two at least partially overlapping first-layer CARs). This contributes to saving storage space for storing identifiers for the second-layer grid elements. For instance, the identifier of the first-layer CAR that caused the adding of the second-layer grid element to the second-layer CAR for the first time is stored for the second-layer grid element.

The storage of first-layer CAR identifiers for second-layer grid elements 62 is exemplarily illustrated in the second subfigure of FIG. 6a. Therein, for second-layer grid elements b2, c2, d2, b3, c3 and d3, an identifier “CID2” identifying the first-layer CAR 60-2 (and thus also the first-layer coverage area represented by this first-layer CAR and/or the CPE that provides this coverage area) has been stored, and wherein for second-layer grid elements d1, e1 and e2, an identifier “CID1” identifying the first-layer CAR 60-1 (and thus also the first-layer coverage area represented by this first-layer CAR and/or the CPE that provides this coverage area) has been stored. It is assumed that, with respect to second-layer grid element d2, which contains at least a part of both the first-layer CAR 60-1 and the first-layer CAR 60-2, only an identifier of the first-layer CAR 60-2 is stored (for instance because this first-layer CAR 60-2 caused initial addition or last refreshing of the second-layer grid element d2 to/in the second-layer CAR 63.

For a second-layer grid element, further information such as for instance a timestamp (for instance indicating the time when the second-layer grid element was added to or refreshed in the second-layer CAR) may be stored, as will be further discussed below.

Example embodiments of the invention add, to the third embodiment of the invention, the feature that for each second-layer grid element that is removed from the second-layer CAR in the updating of the second-layer CAR based on the decision whether the first-layer CAR of the first-layer coverage area has changed to an extent that exceeds a pre-defined or determined extent or not, an identifier of the first-layer CAR stored for the second-layer grid element is deleted.

Example embodiments of the invention add, to the third embodiment of the invention, the features that, in the updating, in case of a decision that the first-layer CAR of the first-layer coverage area has changed to an extent that exceeds a pre-defined or determined extent, one or more second-layer grid elements of the second-layer grid that respectively do not contain any part of the first-layer CAR but contain at least a part of an unchanged first-layer CAR of the first-layer coverage area are identified, and that for each identified second-layer grid element, it is checked if an identifier of the first-layer CAR is stored, and if this is case, the identifier of the first-layer CAR is deleted for the identified second-layer grid element. Thus changes in the first-layer CAR only trigger updates (removal of one or more second-layer grid elements) in the second-layer CAR if the changes are considered substantial (as checked by the exceeding of the pre-defined/determined extent), and these updates are confined to those second-layer grid elements that are actually affected by the changes. This vastly contributes to reduce the computational complexity of updating higher-layer CARS.

As described above, at least for removal of second-layer grid elements from the second-layer CAR, only identified second-layer grid elements for which an identifier of the first-layer CAR is stored may be considered. Of course, there may be further identified second-layer grid elements that have been updated based on changes in other first-layer CARs (and according identifiers of these first-layer CARs have been stored for them), but these further second-layer grid elements are not removed, since they are indicated to pertain to other first-layer CARs only (which may currently not have changed).

Example embodiments of the invention add, to the third embodiment of the invention, the features that, in the updating, in case of a decision that the first-layer CAR of the first-layer coverage area has changed to an extent that exceeds a pre-defined or determined extent, one or more second-layer grid elements of the second-layer grid that respectively contain at least a part of the first-layer CAR of the first-layer coverage area but do not contain any part of an unchanged first-layer CAR of the first-layer coverage area are identified, and that for each identified second-layer grid element, it is checked if an identifier of any first-layer CAR is stored for the identified second-layer grid element, and if this is not the case, the identifier of the first-layer CAR is stored for the identified second-layer grid element. Thus changes in the first-layer CAR only trigger updates (addition of second-layer grid elements) in the second-layer CAR if the changes are considered substantial (as checked by the exceeding of the pre-defined/determined extent), and these updates are confined to those second-layer grid elements that are actually affected by the changes. This vastly contributes to reduce the computational complexity of updating higher-layer CARs.

As described above, frequent storage operations of first-layer CAR identifiers for second-layer grid elements may be avoided by only storing first-layer CAR identifiers for second-layer grid elements if no first-layer CAR identifiers are already stored for the second-layer grid elements (i.e. if the second-layer grid elements are not yet part of the second-layer CAR). This approach may however be refined by considering timestamps, as will be further discussed with reference to the fourth example embodiment of the invention below.

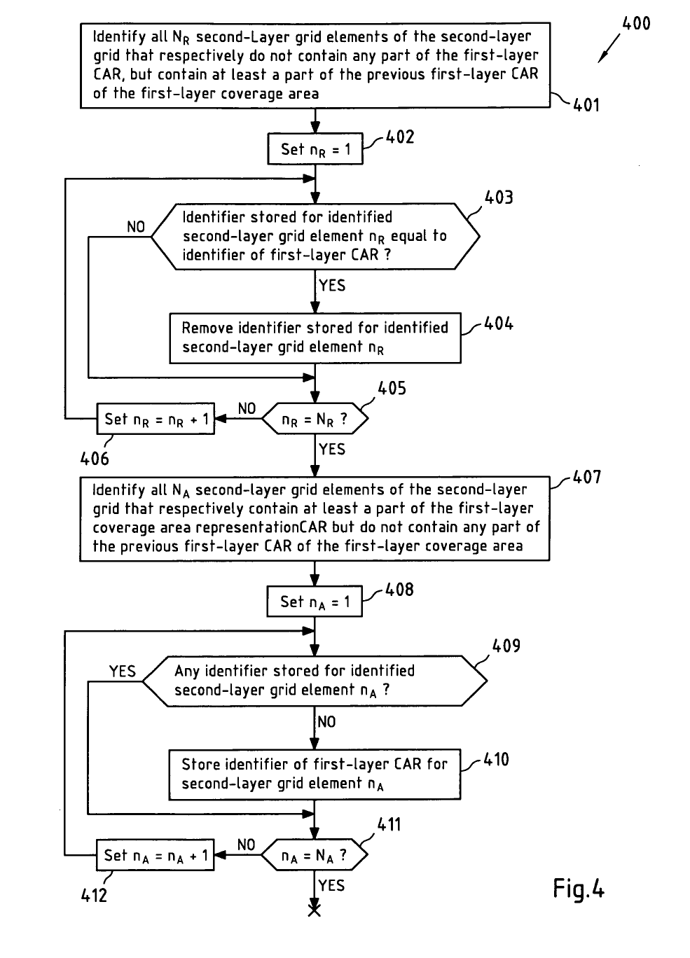

FIG. 4 shows a flowchart 400 of the method according to the third example embodiment of the invention. The steps 401-412 of this flowchart 400 may for instance be sub-steps of step 303 of the flowchart 300 of FIG. 3, for instance when step 303 is directed to updating of the second-layer CAR (rather than only triggering of the updating of the second-layer CAR).

Alternatively, steps 401-412 of flowchart 400 may for instance be entirely performed in response to a triggering of updating the second-layer CAR, which triggering may also result from step 303 of flowchart 300. If the steps 401-412 of flowchart 400 are performed by a first functional unit that is different from a second functional unit that performs the triggering of the updating (step 303 of flowchart 300), it may for instance be necessary to provide the first functional unit with information on the current first-layer CAR (i.e. the first-layer CAR including the change) and the previous first-layer CAR (i.e. the first-layer CAR without the change) and with information allowing to identify the specific second-layer CAR to which the first-layer CAR pertains. This latter information may for instance be derived from a DN chain that identifies the first-layer CAR.

Turning now to flowchart 400, it should be noted that the method of this flowchart 400 is based on the example assumption that a second-layer grid element is indicated to be part of the second-layer coverage if an identifier of a first-layer CAR has been stored for this second-layer grid element. Thus, if no first-layer CAR identifier is stored for a second-layer grid element, this grid element is not considered to be a part of the second-layer CAR to which the second-layer grid pertains.

In a step 401, all N_{R} second-layer grid elements of the second-layer grid that respectively do not contain any part of the (current) first-layer CAR, but contain at least a part of the previous (unchanged) first-layer CAR of the first-layer coverage area are identified as candidates for removal.

Steps 402, 405 and 406 implement a loop controlled by run variable n_{R} that runs through all N_{R} second-layer grid elements (that are removal candidates). For each of these second-layer grid elements, it is checked in step 403 if an (first-layer CAR) identifier stored for the respective second-layer grid element n_{R} equals an identifier of the first-layer CAR (on which step 401 is based). If this is the case, the identifier stored for this second-layer grid element is removed in step 404. As explained above, this removes this second-layer grid element from the second-layer CAR. If step 403 returns a negative result, step 404 is skipped.

If all N_{R} second-layer grid elements that are potentially to be removed from the second-layer CAR have been processed, flowchart 400 proceeds to step 407.

In step 407, then all N_{A} second-layer grid elements of the second-layer grid that respectively contain at least a part of the current first-layer CAR of the first-layer coverage area but do not contain any part of the previous (unchanged) first-layer CAR of the first-layer coverage area are identified as candidates for addition to the second-layer CAR.

Steps 408, 411 and 412 implement a loop controlled by run variable n_{A} that runs through all N_{A} second-layer grid elements (that are addition candidates). For each of these second-layer grid elements, it is checked in step 409 if any (first-layer CAR) identifier is stored for the respective second-layer grid element n_{A}. If this is not the case, an identifier of the first-layer CAR (on which step 407 is based) is stored for the second-layer grid element n_{A} in a step 410. As explained above, this adds the second-layer grid element to the second-layer CAR. If step 409 returns a positive result, it is judged that the second-layer grid element is already part of the second-layer CAR, so that no action is necessary and step 410 can be skipped.

If all N_{A} second-layer grid elements that are potentially to be added to the second-layer CAR have been processed, flowchart 400 terminates.

FIGS. 6a and 6b provide an example for the updating of a second-layer CAR 63 according to the third embodiment of the invention. Therein, the respective first subfigures of FIGS. 6a and 6b illustrate changes in the first-layer CARs 60-1 and 60-2 (to become first-layer CARs 60-1′ and 60-2′), and the respective second subfigures of FIGS. 6a and 6b show the resulting updating of the second-layer CAR 63 (to become second-layer 63′). It is assumed that first-layer CAR 60-1 is shifted rightwards, and that first-layer CAR 60-2 grows, as indicated by the arrows in the first subfigure of FIG. 6b.

Furthermore, it is exemplarily assumed that the first-layer CAR is decided to have changed to an extent that exceeds a pre-defined or determined extent (thus triggering updating of the associated second-layer CAR) if an amount of change of at least one parameter of the first-layer CAR exceeds a dimension of a second-layer grid element 62 of the second-layer grid 62 multiplied by a factor of 0.5. Consequently, since the lengths of the minor-axis and the major-axis of first-layer CAR 60-2′ change less than half a dimension of a second-layer grid element 62, this change does not cause an updating of second-layer CAR 63. It can thus be seen in the second subfigures of FIGS. 6a and 6b that the second-layer grid elements b2, c2, d2, b3, c3, d3 pertaining to the first-layer CAR 60-2/60-2′ all remain part of the second-layer CAR 63′.

However, the translatory movement of the centre position of first-layer CAR 60-1 exceed the threshold of half a dimension of a grid element 62, and thus causes updating of the second-layer CAR 63. This is performed by executing the steps of flowchart 400 of FIG. 4.

Therein, as potential removal candidates, second-layer grid elements d1 and d2 are identified (step 401), but only second-layer grid element d1 will be removed from second-layer CAR 63 (by deleting the first-layer CAR identifier “CID1” stored therein) (step 404), because second-layer grid element d1 has an identifier (“CID1”) of the first-layer CAR 60-1′ that causes the updating stored for it (step 403->positive), and because second-layer grid element d2 has another identifier (“CID2”) than the identifier of the first-layer CAR 60-1′ that causes the updating stored for it (step 403->negative).

As potential addition candidates, second-layer grid elements f1 and f2 are identified (step 407). Both of them will be included into the second-layer CAR 63′ by storing identifiers “CID1” for them (step 410), because no first-layer CAR identifier has been stored for these two second-layer grid element before (step 409->negative).

In summary, it can be seen that the updated second-layer CAR 63′ adequately represents the changes in the two first-layer CARs 60-1′ and 60-2′, while only the changes in first-layer CAR 60-1′ were considered substantial enough to cause an updating of the second-layer CAR 63′, thus significantly reducing the frequency and computational complexity of second-layer updating operations.

A fourth example embodiment of the invention adds, to the third embodiment of the invention, the features that both an identifier of the first-layer CAR and a timestamp are stored for each second-layer grid element that has been added to or refreshed in the second-layer CAR in a previous updating of the second-layer CAR based on a decision that the first-layer CAR of this first-layer coverage area has changed to an extent exceeding a pre-defined or determined extent, that, in the updating, in case of a decision that the first-layer CAR of the first-layer coverage area has changed to an extent that exceeds a pre-defined or determined extent, one or more second-layer grid elements of the second-layer grid that respectively contain at least a part of the first-layer CAR of the first-layer coverage area but do not contain any part of an unchanged first-layer CAR of the first-layer coverage area are identified, that for each identified second-layer grid element, it is checked if an identifier of any first-layer coverage area representation is stored for the identified second-layer grid element, that if this is not the case, the identifier of the first-layer coverage area representation and a timestamp are stored for the identified second-layer grid element, and that if this is the case, the identifier of the first-layer coverage area representation and the timestamp are only stored for the identified second-layer grid element if the already stored timestamp is older than a pre-defined or determined threshold.

In the fourth example embodiment of the invention, in addition to first-layer CAR identifiers, also timestamps are stored for second-layer grid elements of the second-layer CAR. In this way, on the one hand, it is for instance possible to refresh second-layer grid elements that are comprised in the second-layer CAR already for a long time, while, on the other hand, the number of refresh/update operations can be kept small since only old second-layer grid elements are updated.

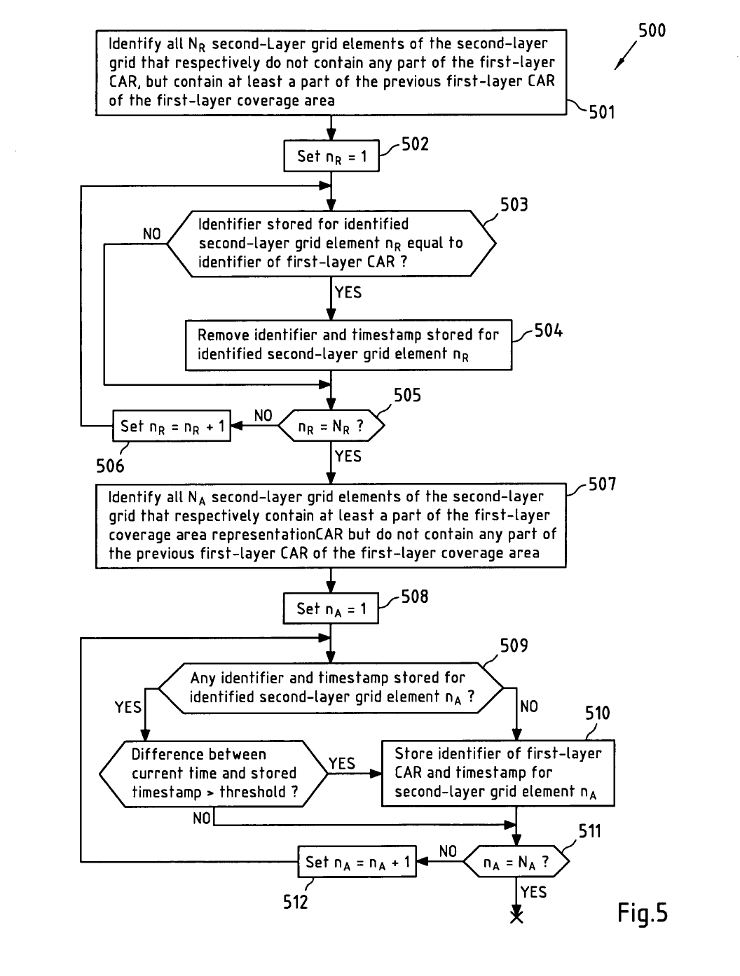

FIG. 5 shows a flowchart 500 of the method according to the fourth example embodiment of the invention. For this flowchart 500, and in particular its association with step 303 of flowchart 300 of FIG. 3, the above description for flowchart 400 applies accordingly.

With respect to flowchart 500, similar as for flowchart 400, it should be noted that the method of this flowchart 500 is based on the example assumption that a second-layer grid element is indicated to be part of the second-layer coverage if an identifier and a timestamp of a first-layer CAR has been stored for this second-layer grid element. Thus, if no first-layer CAR identifier/timestamp is stored for a second-layer grid element, this grid element is not considered to be a part of the second-layer CAR to which the second-layer grid pertains.

The explanation of steps 501-512 is basically the same as already respectively presented for steps 401-412 of the flowchart 400 of FIG. 4 above, with the following differences:

In step 504, the identifier and the timestamp stored for the identified second-layer grid element n_{R} is removed.

In step 509, it is checked if any (first-layer CAR) identifier and a timestamp is stored for the respective second-layer grid element n_{A}. If this is the case, it is checked in a step 513 if a difference between a current time and the stored timestamp exceeds a threshold, which would indicate that the second-layer grid element n_{A} is “old” and should be refreshed. Accordingly, if the check in step 513 is positive, the flowchart 500 proceeds to step 510, where an identifier of the first-layer CAR (on which step 507 is based) and a timestamp (for instance indicating the present time) is stored for the second-layer grid element n_{A}. Alternatively, if the check in step 513 is negative, the flowchart 500 proceeds to step 511.

The impact of the operation of the fourth example embodiment of the invention can again be explained with reference to the example of FIGS. 6a and 6b by considering the case that, for each of the second-layer grid elements composing the second-layer CAR 63 (see the second subfigure of FIG. 6a), additionally a respective timestamp would be stored, which indicates a time when the respective second-layer grid element was added to or refreshed in the second-layer CAR 63 (by storing an identifier of the first-layer CAR that caused the addition/refreshing of the second-layer grid element), and assuming that also grid elements f1 and f2 would be part of the second-layer CAR 63 and would have an identifier of a further first-layer CAR and a timestamp stored for it. This may for instance be the case because the second-layer coverage area represented by second-layer CAR 63 comprises a further first-layer coverage area the first-layer CAR of which is not shown in FIG. 6a.

Now, if the second-layer CAR 63 is at least partially updated due to substantial changes at least in the first-layer CAR 60-1, as explained in detail above with reference to FIG. 6b, second-layer grid elements f1 and f2 would not be straightforwardly added to the updated second-layer CAR 63′, as explained with reference to steps 409 and 410 of flowchart 400 above. In contrast, steps 509, 513 and 510 would be performed here. Since identifiers and timestamps would then already have been stored for second-layer grid elements f1 and f2 (step 509->positive), it would be checked in step 513 if the timestamps stored for the second-layer grid elements f1 and f2 are “old” (e.g. older than pre-defined number of days, or a week, or a month, etc.), and if this was found to be true, identifiers of the first-layer CAR 60-1/60-1′ would be stored for them, together with a timestamp indicating a current time. In this way, thus second-layer grid elements f1 and f2, and, correspondingly, second-layer CAR 63, has been refreshed (to obtain second-layer CAR 63′).

A method according to a fifth example embodiment of the invention is based on any of the first to fourth embodiments of the invention and further comprises updating or triggering updating of a third-layer CAR of a third-layer coverage area at least in dependence on a decision whether the second-layer coverage area has changed, due to an updating thereof, to an extent that exceeds a pre-defined or determined extent or not, wherein the third-layer coverage area is part of the hierarchy of coverage areas of the communication system, and wherein the third-layer coverage area at least comprises the second-layer coverage area.

Here thus the concept of substantial changes in a lower-layer CAR triggering updating of a higher-layer CAR is extended to a hierarchy of three CARs, with a substantial reduction of the computational complexity for updating the second-layer CAR and an even further reduction of the computational complexity for updating the third-layer CAR. Further extension of this concept to a fourth-layer CAR or even higher-layer CARs is straightforward. Accordingly, the above-description of the example embodiments of the invention pertaining to cases where a first-layer CAR and a second-layer CAR are considered can be readily transferred to cases where a second-layer CAR and a third-layer CAR (or a third-layer CAR and a fourth-layer CAR) are considered and shall be considered to be equally disclosed for all of these.

According to the fifth example embodiment of the invention, the third-layer CAR may be composed of a set of one or more grid elements of a third-layer grid. The third-layer grid may for instance be coarser than the second-layer grid. The third-layer grid element may for instance consist of an integer number of second-layer grid elements.

The third subfigure of FIG. 6a illustrates an example of a third-layer CAR 66 that is composed of third-layer grid elements 65 of a third-layer grid 64, which is much coarser than the second-layer grid 61 (a third-layer grid element 65 comprises four second-layer grid elements 62). The third-layer CAR 66 represents a third-layer coverage area, e.g. the coverage area identified by a MNC, that comprises two second-layer coverage areas, e.g. location areas. For the third-layer grid elements that compose the third-layer CAR 66, identifiers of the respective second-layer CARs that caused the addition/refreshing of the third-layer to/in the third-layer CAR 66 is stored (optionally with timestamps). As can be seen, third-layer grid elements A1, B1, C1, A2 and B2 have second-layer CAR identifiers “LAC1” stored for them, since these third-layer grid elements have been added/refreshed based on the second-layer CAR 63 (see the second subfigure of FIG. 6a). Third-layer grid element C3 has an identifier “LAC2” stored for it, which identifies a further second-layer CAR not shown in FIG. 6a, since it is for instance represented by second-layer grid elements of a further second-layer grid (which may nevertheless have the same grid element size as the second-layer grid 61).

The third-layer CAR 66 may for instance only be updated if a second-layer CAR associated with it (e.g. second-layer CAR 63) is decided to have changed to an extent that exceeds a pre-defined or determined extent. This may for instance be considered to be the case if one or more grid elements have to be added or removed from the third-layer CAR to reflect the changes in the second-layer CAR.

In the example of updating the second-layer CAR 63 to obtain the updated second-layer CAR 63′ as explained with reference to FIGS. 6a and 6b above, the second-layer CAR 63 was updated by removing second-layer grid element d1 and adding second-layer grid elements f1 and f2. These changes would not cause an update of the third-layer CAR 66, since they do not require addition or removal of third-layer grid elements to be reflected by the third layer CAR 66 (both the second-layer CAR 63 and the updated second-layer CAR 63′ are within the third-layer CAR 66, as can be seen in the respective third subfigures of FIGS. 6a and 6b in dashed lines). However, if for instance second-layer grid element e3 would have been included in the updated second-layer CAR 63′, this would have caused an updating of the third-layer CAR 66 as well.

From the example of FIGS. 6a and 6b, it is clearly visible that changes in the first-layer CARs 60-1 and 60-2 (which may for instance be updated due to new fingerprints) only in part cause an updating of the super-ordinated second-layer CAR 63, and cause no updating of the super-ordinated third-layer CAR 66. It has thus been shown that a frequency and computational complexity of higher-layer update procedures can be significantly reduced by example embodiments of the invention. Nevertheless, the updated second-layer CAR 63′ and/or the third-layer CAR 66 are still accurate enough to be usable as fall-back solutions in case a sub-ordinated first-layer CAR is not available.

As described above, some example embodiments of the invention model higher-layer coverage areas (e.g. coverage areas of LACs, RNCs, MNCs, MCCs) in cellular networks in an efficient way to achieve a minimum number of updates, inter alia by:
Using a grid-based approach for the higher-layer CARs and selecting the grid granularity based on the type of coverage area (e.g. an MCC grid can have a much coarser granularity than, e.g., a LAC grid).
Storing in the grid IDs of lower-layer CARs with a timestamp indicating the update time.
Only updating higher-layer CARs in case lower-layer CAR changes more than a threshold.
Using both the old and new lower-layer CAR for the update so that in case the lower-layer CAR retreats from a given area (e.g. cell movement) the higher-layer grid can be trivially cleaned and updated.

In the following, features of a sixth example embodiment of the invention will be described, which is a combination of most features of the first to fifth example embodiments described above with particular reference to the hierarchy of coverage areas illustrated in FIG. 2.

According to the sixth example embodiment of the invention, the coverage areas (LAC, RNC, eNB, TAC, RZ, MCC, MNC, SID, NID) are modelled using a grid approach, with the grid density depending upon the Layer of the coverage area being modelled. Thus when modelling Layer-2 coverage areas (LAC, RNC, eNB, TAC, RZ), a grid density (grid element size) of for instance 5 km may be utilized, because the coverage area size is anyhow in the order of 50 to 100 km so that better granularity may not be required. The next higher layers (MCC, SID, MNC, NID) may already use a granularity (grid element size) of for instance 50 km, because the accuracy requirements are even less in case of network or country fallback.

The natural layering in the cellular networks is used to model coverage areas so that Layer-2 CARs carry Layer-1 CAR IDs (e.g. Cell IDs) in their grids, Layer-3 CARs carry Layer-2 CAR IDs (LAC, RNC, etc.) in their grids and finally, Layer-4 CARS carry Layer-3 CAR IDs (MNC) in their grids. Each grid element carries just one, say, Layer-1 CAR ID and timestamp, when the grid element was updated.

The samples used to model Layer-(N+1) CARS are Layer-(N) CARs, where N={1,2,3}. This means that the sample received for a cell MCC-MNC-LAC-CID=1-1-1-1 is used to update only the Layer-2 CAR (MCC-MNC-LAC=1-1-1). Then this Layer-2 CAR (if there are changes) is used to update the higher layer (Layer-3, MCC-MNC=1-1) CAR.

Only in case the Layer-(N) CAR changes its shape (more than a certain pre-defined threshold), its CAR is provided to updating Layer-(N+1) CAR. This limits the number of updates significantly.

The Layer-(N+1) CAR is updated in such a way that:
In case the grid element to be updated does not have prior data, data is added to the grid element. Note that setting LAC grid granularity to 5 km means that, on average one cell may update only four LAC grid elements, because the global average diameter of cells is in the order of two kilometres.
In case the grid element has prior data, the data in the grid element (Layer-(N) CAR ID, current time) is updated only in case the prior timestamp is older than a pre-defined threshold. This limits the number of updates significantly. The purpose of this is to keep the updates to the already known grid elements to a minimum, but still allows periodically updating the grid element timestamp to indicate that the Layer-(N+1) CAR extends to that grid element.

In case a Layer-(N) CAR changes, the input to the process updating the Layer-(N+1) CAR is both the previous and updated Layer-(N) CAR. The updating process can adjust the Layer-(N+1) grid in case the Layer-(N) CAR shrinks or changes its shape.

Removing data from a Layer-(N+1) grid element functions so that if the Layer-(N) CAR ID is in the Layer-(N+1) CAR grid element, the grid element data is cleared. Otherwise, the grid element data is left intact.

It may be advantageous to provide the update process also the old CAR so that the update process can first check if data need to be removed from the following candidate grid elements (GEs):

CANDIDATE GEs FOR DATA REMOVAL=OLD GEs−overlap(OLD GEs,NEW GEs)

In this way, the update process does not need to go through the whole Layer-(N+1) grid to search for the grid element with the Layer-(N) CAR ID when updating the Layer-(N+1) CAR. Since often the changes are not small (like a cell changing its location), in practice otherwise the whole grid would need to be searched. However, with the knowledge of the prior CAR, the correct grid elements from which data potentially needs to be removed can be calculated trivially and quickly checked without tedious work of running through the whole grid.

As a special case, when the Layer-(N) CAR needs to be removed completely from the Layer-(N+1) grid, then the new CAR to be provided for the Layer-(N+1) CAR update process is an empty object. Thus, when the data is first removed from the grid based on the old CAR, nothing is put back based on the new CAR (because there is no such thing).

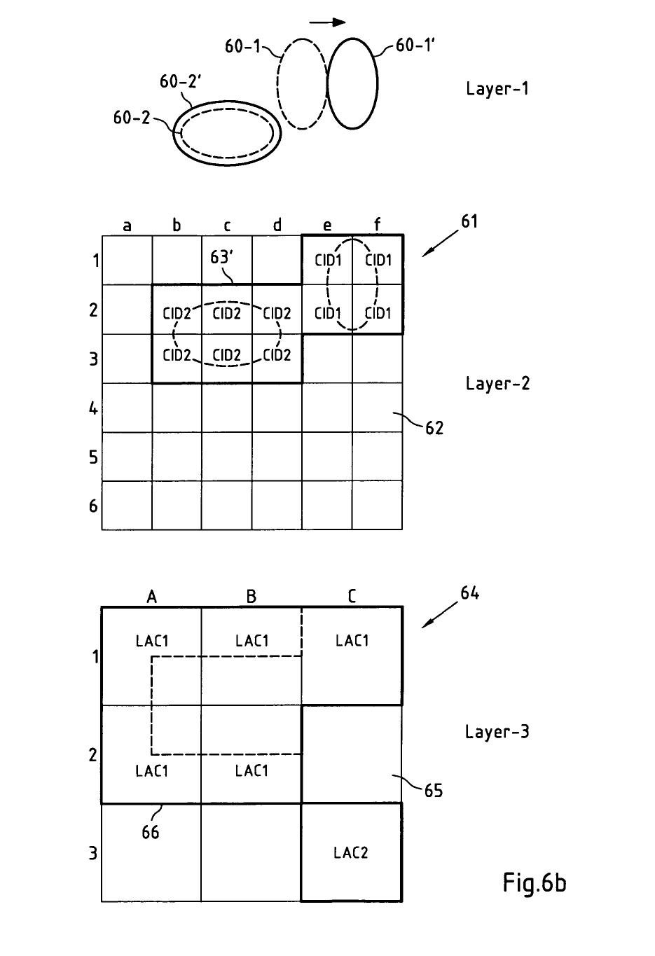

FIG. 7 is a schematic block diagram of an example embodiment of an apparatus 7 according to the invention. Apparatus 7 may for instance be or form a part of server 3 of system 1 (see FIG. 1a or 1b), which may in turn be representative of a cloud-based service. Apparatus 7 may for instance be configured to implement and/or comprise means for performing any of the first to sixth example embodiments of the invention described above.

Apparatus 7 comprises a processor 70, which may for instance be embodied as a microprocessor, Digital Signal Processor (DSP) or Application Specific Integrated Circuit (ASIC), to name but a few non-limiting examples. Processor 70 executes a program code stored in program memory 71. Program memory 71 may also be included into processor 70. Program memory 71 may be fixedly connected to processor 70, or removable from processor 70, for instance in the form of a memory card or stick. Program memory 71 and the computer program code stored therein may be configured to, with processor 70, cause apparatus 7 at least to perform the methods according to any of the first to sixth example embodiments of the invention described above.

Processor 70 further interfaces with a main memory 72, which may for instance be embodied as a Random Access Memory (RAM) to support its operation.

Processor 70 further can access (e.g. read from and/or write to) a database 73, which may for instance be embodied as a mass storage device, for instance with capacities of several Gigabytes or several Terabytes. It may either be fixedly connected to processor 31, or may be releasably connectable thereto. Processor 70 may for instance access database 73 via a network, for instance via the Internet. Database 73 may for instance store a plurality of CARs. Database 73 may for instance be a radiomap database. Depending on the task performed by processor 70, the contents of database 73 may differ.

For instance, if processor 70 is responsible for updating first-layer CARs, database 73 may for instance at least or only store first-layer CARS of first-layer coverage areas of one or more communication systems (or of limited regions thereof).

If processor 70 is responsible for updating second-layer CARs based on a decision whether associated first-layer CARs have changed to an extent that exceeds a pre-defined or determined extent, database 73 may for instance at least or only store second-layer CARS of second-layer coverage areas of one or more communication systems (or of limited regions thereof).

Processor 70 may of course also be responsible for updating both first-layer and second-layer CARs (and perhaps also of higher-layer CARs), and database 73 may then for instance at least or only store first-layer CARs of first-layer coverage areas and second-layer CARs of second-layer coverage areas of one or more communication systems (or of limited regions thereof).

Processor 70 further controls an interface 75 configured to receive and/or output information. Via this interface 75, for instance information on fingerprints may be received, which are then used by processor 70 to update first-layer CARs (interface 75 then may for instance be a communication interface for communication with a collector terminal, such as collector terminal 2-2 of FIG. 1b, for instance via a radio interface of a cellular radio communication system). Equally well, information on the decision whether a first-layer CAR has changed to an extent that exceeds a pre-defined or determined extent may be received by processor 70 via interface 75, for instance from another processor. Processor 70 may also use interface 75 to output information (e.g. to another processor) that triggers updating of a second-layer CAR in case processor 70 has decided that an associated first-layer CAR has changed to an extent that exceeds a pre-defined or determined extent.

Apparatus 7 may optionally comprise a user interface 74 configured to present information to a user/operator of apparatus 7 and/or to receive information (e.g. configuration parameters such as information on the pre-defined extent and/or threshold values) from such a user/operator.

It is to be noted that the circuitry formed by the components of apparatus 7 may be implemented in hardware alone, partially in hardware and in software, or in software only, as further described at the end of this specification.

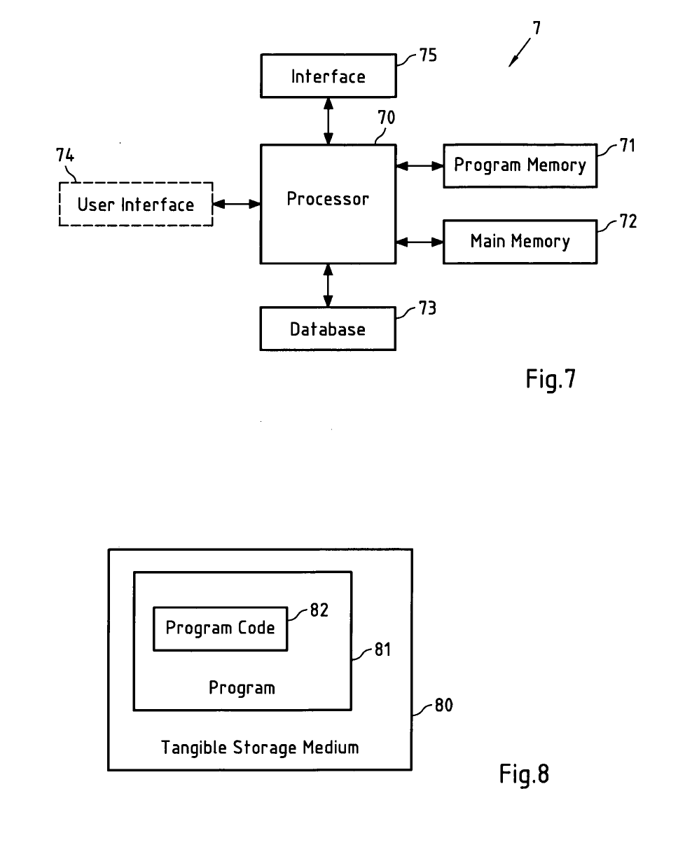

FIG. 8 is a schematic illustration of an embodiment of a tangible storage medium 80 according to the invention. This tangible storage medium 80, which may in particular be a non-transitory storage medium, comprises a computer program 81, which in turn comprises program code 82 (for instance a set of instructions). A realization of tangible storage medium 80 may for instance be program memory 71 of apparatus 7 (see FIG. 7). Program code 82 may for instance be program code for performing the method according to any of the first to sixth example embodiments of the invention (e.g. the flowcharts 300, 400 and 500 of FIGS. 3-5) when computer program 81 is executed on a processor (e.g. processor 70 of apparatus 7 of FIG. 7).

As used in this application, the term ‘circuitry’ refers to all of the following:

(a) hardware-only circuit implementations (such as implementations in only analog and/or digital circuitry) and
(b) combinations of circuits and software (and/or firmware), such as (as applicable):
(i) to a combination of processor(s) or
(ii) to portions of processor(s)/software (including digital signal processor(s)), software, and memory(ies) that work together to cause an apparatus, such as a mobile phone or a positioning device, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a positioning device.

As used in this application, the wording “X comprises A and B” (with X, A and B being representative of all kinds of words in the description) is meant to express that X has at least A and B, but can have further elements. Furthermore, the wording “X based on Y” (with X and Y being representative of all kinds of words in the description) is meant to express that X is influenced at least by Y, but may be influenced by further circumstances. Furthermore, the undefined article “a” is—unless otherwise stated—not understood to mean “only one”.

The invention has been described above by means of embodiments, which shall be understood to be non-limiting examples. In particular, it should be noted that there are alternative ways and variations which are obvious to a skilled person in the art and can be implemented without deviating from the scope and spirit of the appended claims. It should also be understood that the sequence of method steps in the flowcharts presented above is not mandatory, also alternative sequences may be possible.

All embodiments disclosed in this specification shall be understood to be also disclosed in all possible combinations with each other.

1-24. (canceled)

25. A method, performed by an apparatus, the method at least comprising:
updating or triggering updating of a second-layer coverage area representation of a second-layer coverage area at least in dependence on a decision whether a first-layer coverage area representation of a first-layer coverage area has changed to an extent that exceeds a pre-defined or determined extent or not, wherein the first-layer coverage area and the second-layer coverage area are part of a hierarchy of coverage areas of a communication system, and wherein the second-layer coverage area at least comprises the first-layer coverage area.

26. The method according to claim 25, wherein the decision is based on position information provided by a terminal associated with a coverage-area providing entity of the first-layer coverage area.

27. The method according to claim 25, wherein the second-layer coverage area representation is composed of a set of one or more grid elements of a second-layer grid.

28. The method according to claim 27, wherein the first-layer coverage area representation is decided to have changed to an extent that exceeds a pre-defined or determined extent if one or more grid elements have to be added or removed from the second-layer coverage area representation to reflect the changes in the first-layer coverage area representation.

29. The method according to claim 27, wherein the first-layer coverage area representation is decided to have changed to an extent that exceeds a pre-defined or determined extent if an amount of change of at least one parameter of the first-layer coverage area representation exceeds a pre-defined or determined threshold.

30. The method according to claim 29, wherein the threshold equals a dimension of a second-layer grid element of the second-layer grid multiplied by a factor that is larger than 0 and smaller than or equal to 1.

31. The method according to claim 30, wherein the factor is 0.5.

32. The method according to claim 27, wherein the first-layer coverage area representation is composed of a set of one or more first-layer grid elements of a first-layer grid, and wherein the second-layer grid is coarser than the first-layer grid.

33. The method according to claim 25, wherein the first-layer coverage area representation is composed of a set of one or more grid elements of a first-layer grid, and wherein the first-layer coverage area representation is decided to have changed to an extent that exceeds a pre-defined or determined extent if one or more grid elements have to be added or removed from a previous first-layer coverage area representation to obtain the first-layer coverage area representation.

34. The method according to claim 27, wherein for each second-layer grid element that has been added to or refreshed in the second-layer coverage area representation in a previous updating of the second-layer coverage area representation based on a decision that a first-layer coverage area representation of a first-layer coverage area has changed to an extent exceeding a pre-defined or determined extent, an identifier of this first-layer coverage area representation is stored.

35. The method according to claim 34, wherein for each second-layer grid element that is removed from the second-layer coverage area representation in the updating of the second-layer coverage area representation based on the decision whether the first-layer coverage area representation of the first-layer coverage area has changed to an extent that exceeds a pre-defined or determined extent or not, an identifier of the first-layer coverage area representation stored for the second-layer grid element is deleted.

36. The method according to claim 34, wherein, in the updating, in case of a decision that the first-layer coverage area representation of the first-layer coverage area has changed to an extent that exceeds a pre-defined or determined extent, one or more second-layer grid elements of the second-layer grid that respectively do not contain any part of the first-layer coverage area representation but contain at least a part of an unchanged first-layer coverage area representation of the first-layer coverage area are identified, and wherein for each identified second-layer grid element, it is checked if an identifier of the first-layer coverage area representation is stored, and if this is case, the identifier of the first-layer coverage area representation is deleted for the identified second-layer grid element.

37. The method according to claim 34, wherein, in the updating, in case of a decision that the first-layer coverage area representation of the first-layer coverage area has changed to an extent that exceeds a pre-defined or determined extent, one or more second-layer grid elements of the second-layer grid that respectively contain at least a part of the first-layer coverage area representation of the first-layer coverage area but do not contain any part of an unchanged first-layer coverage area representation of the first-layer coverage area are identified and wherein for each identified second-layer grid element, it is checked if an identifier of any first-layer coverage area representation is stored for the identified second-layer grid element, and if this is not the case, the identifier of the first-layer coverage area representation is stored for the identified second-layer grid element.

38. The method according to claim 27, wherein both an identifier of the first-layer coverage area representation and a timestamp are stored for each second-layer grid element that has been added to or refreshed in the second-layer coverage area representation in a previous updating of the second-layer coverage area representation based on a decision that the first-layer coverage area representation of this first-layer coverage area has changed to an extent exceeding a pre-defined or determined extent, wherein, in the updating, in case of a decision that the first-layer coverage area representation of the first-layer coverage area has changed to an extent that exceeds a pre-defined or determined extent, one or more second-layer grid elements of the second-layer grid that respectively contain at least a part of the first-layer coverage area representation of the first-layer coverage area but do not contain any part of an unchanged first-layer coverage area representation of the first-layer coverage area are identified, wherein for each identified second-layer grid element, it is checked if an identifier of any first-layer coverage area representation is stored for the identified second-layer grid element, wherein if this is not the case, the identifier of the first-layer coverage area representation and a timestamp are stored for the identified second-layer grid element, and wherein if this is the case, the identifier of the first-layer coverage area representation and the timestamp are only stored for the identified second-layer grid element if the already stored timestamp is older than a pre-defined or determined threshold.

39. The method according to claim 25, further comprising:
updating or triggering updating of a third-layer coverage area representation of a third-layer coverage area at least in dependence on a decision whether the second-layer coverage area has changed, due to an updating thereof, to an extent that exceeds a pre-defined or determined extent or not, wherein the third-layer coverage area is part of the hierarchy of coverage areas of the communication system, and wherein the third-layer coverage area at least comprises the second-layer coverage area.

40. The method according to claim 25, wherein the respective coverage area representations of different layers of the hierarchy of coverage areas of the communication system are provided in a database to allow or at least support positioning of a mobile terminal based on an identification of one or more coverage areas the mobile terminal is associated with, wherein an accuracy of the positioning of the mobile terminal is highest when based on coverage area representations of the lowest-layer coverage areas and decreases when based on coverage area representations of higher-layer coverage areas, and wherein coverage area representations of higher-layer coverage areas serve as a fall back solution in cases where coverage area representations for lower-layer coverage areas with which the mobile terminal is associated are not or only partially available.

41. The method according to claim 25, wherein said communication system is a cellular radio communication system.

42. A computer program at least comprising:
program code for performing the method according claim 1 when said computer program is executed on a processor.

43. An apparatus, comprising at least one processor; and at least one memory including computer program code, said at least one memory and said computer program code configured to, with said at least one processor, cause said apparatus at least to perform the method according to claim 25.

44. The apparatus according to claim 43, further comprising at least one of a user interface, an antenna and communication network interface.
